(19) United States
(12) Patent Application Publication
(10) Pub. No.: US 2003/0006082 A1
(43) Pub. Date: Jan. 9, 2003

(54) Passenger safety handlebar

(76) Inventor: Ian James Popoff, Encinitas, CA (US)

Correspondence Address: Ian Popoff, 904 Hygeia Ave, Encinitas, CA, 92024, US

(21) Appl. No.: 09/898,662

(22) Filed: Jul. 5, 2001

(51) Int. Cl. B60R 21/00

(52) U.S. Cl. 180/271; 280/748

(57) ABSTRACT

The inventor, Ian Popoff, of Encinitas, Calif., wishes to disclose the novel utility of the Passenger Safety Handlebar. The Passenger Safety Handlebar is a fixed-mounted device to be used with in-line-seating arrangement vehicles, such as motorcycles, snowmobiles, personal watercraft, all-terrain vehicles, and the like, to improve passenger safety and stability while using such vehicles. What is novel with respect to the Passenger Safety Handlebar is primarily the secured-mounting properties of the device to the vehicle (as opposed to the driver of such vehicle), which are not observed in the prior art. Second, the innate nature of the Passenger Safety Handlebar predisposes it against action or movement of either the passenger or driver to each other. Further, the actual location of the Passenger Safety Handlebar is novel with respect to prior art, in that it is forward of the driver of the vehicle, rather than lateral or behind. The improvements over prior inventions are that the Passenger Safety Handlebar does not direct any of the passenger's movements to the driver of the vehicle, and further allow the passenger to transfer all of their inertia to the vehicle through the device, which is exceptionally important during braking and acceleration. The use of such a device improves the passenger's upright stability, and benefits the driver directly by removing the necessity for supporting the passenger during braking and acceleration, and by encouraging a proper vertical positioning of the passenger during turning.

### BACKGROUND OF INVENTION

The applicable Classification Definition is, as writ, Index Number 271 “WITH MEANS FOR PROMOTING SAFETY OF VEHICLE, ITS OCCUPANT OR LOAD, OR AN EXTERNAL OBJECT”. The field of endeavor of this invention is the safety and comfort of persons riding on in-line-seating arrangement vehicular devices, such as motorcycles, snowmobiles, personal watercraft, all-terrain vehicles, and the like. The invention directly applies to the passenger of such vehicles, but as the security and safety of the passenger intimately effects the driver, the invention applies as much to those persons while being used by a passenger on the vehicle. The prior art in this field includes belt-like devices (U.S. Pat. Nos. 4,411,222, 5,081,719, 3,940,166, 5,806,087) and harness-like devices (U.S. Pat. Nos. 4,028,742, 5,289,896, 4,560,097) both of which types rely on the driver to support the inertia and the balance of the passenger with their own physical resistance. In addition, solid-support devices such as a ‘sissy bar’ (backrest), arm-rest, or permanent mounted handles exist (U.S. Pat. Nos. 4,030,750, 4,695,096, 4,111,448, 5,002,149), but are exclusive from the prospective invention as described in this document. These stated inventions allow for the passenger to move freely, or be moved in response to the vehicle contacting obstacles or surface irregularities. Such movements have been attributed to alter the balance of the passenger, and necessitates a counter-movement by the driver, in order to maintain smooth vehicular operations and avoid losing control of the vehicle.

### BRIEF SUMMARY OF THE INVENTION

The object of the invention is to address the issue of passenger safety and comfort on in-line vehicular devices, such as motorcycles, and to provide a device which may increase the stability and security of the passenger on such vehicles, resulting in increased safety. The Passenger Safety Handlebar is a fixed-mounted, secure, hand-gripped device, which provides stability and balance for the passenger of in-line-seating moving vehicles (example, motorcycle). The advantages over currently available devices are as follows. First, the device is not affixed to the driver of the vehicle, hence the advantage that movements by the passenger do not directly cause movement of the driver. Second, the advantage that the device does not restrict the driver's movements, or ability to operate the vehicle in any way. Third, the advantage that the passenger has direct, fixed control over their own stability by means of transferring their inertia to the Passenger Safety Handlebar, which is exceptionally important during acceleration and braking of the vehicle. Fourth, the Passenger Safety Handlebar has the advantage of maintaining the passenger in a rigid, stable position in keeping with the vertical plane of the vehicle during the negotiation of turns, which promotes the appropriate weight distribution and directional force of the passenger's mass during such turns.

### BRIEF DESCRIPTION OF THE SEVERAL VIEWS OF THE DRAWING

FIG. 1 depicts a top view of the Passenger Safety Handlebar.

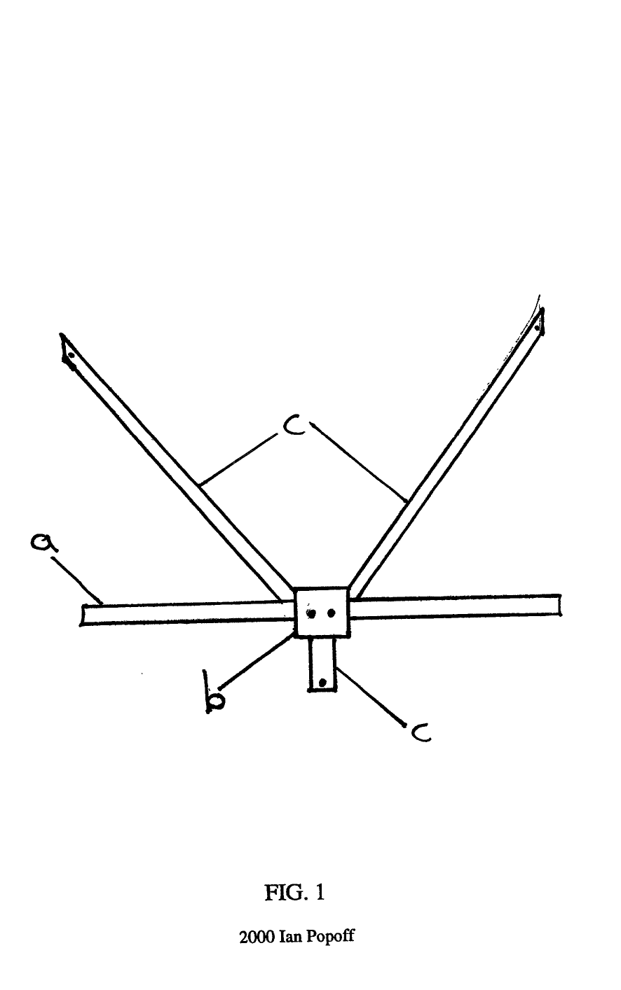

FIG. 2 depicts a side view of the Passenger Safety Handlebar from slightly above.

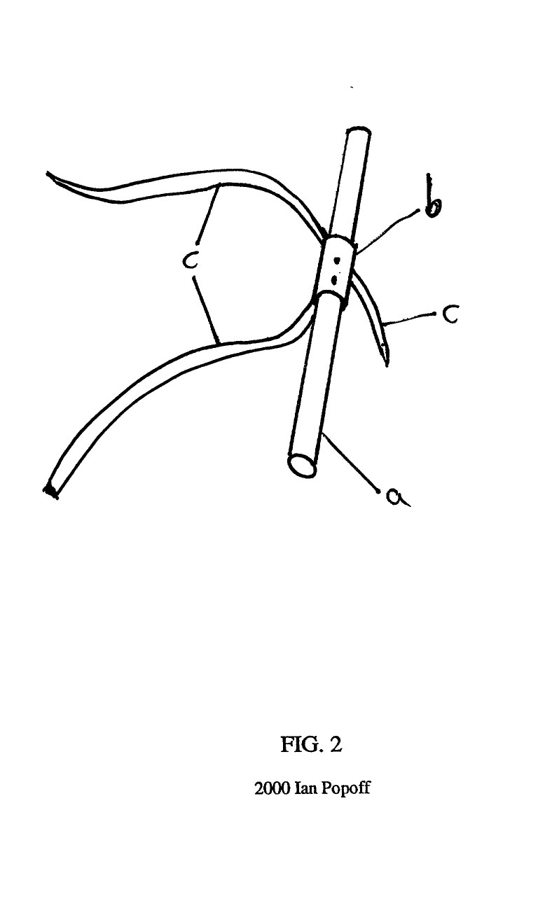

FIG. 3 depicts a rear view of the Passenger Safety Handlebar.

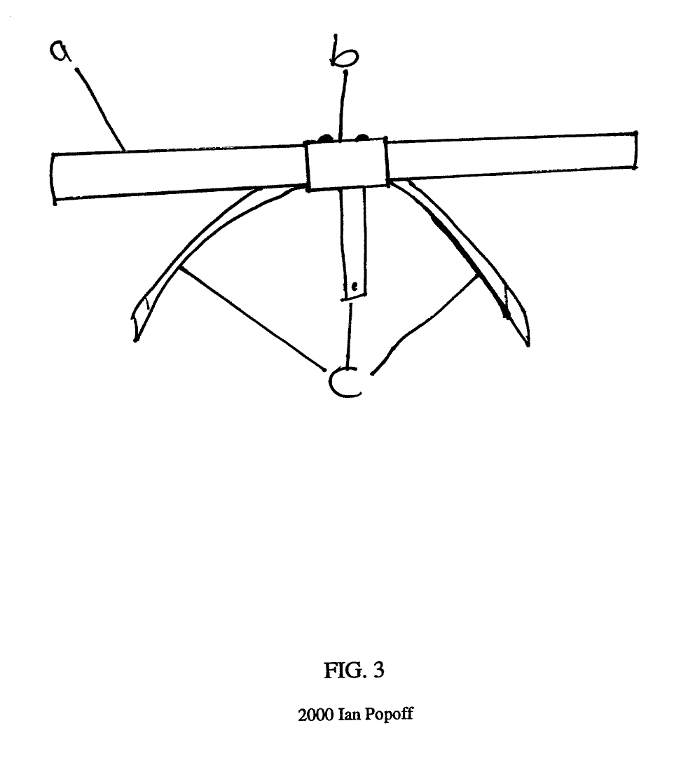

FIG. 4 depicts a side view of the Passenger Safety Handlebar in conjunction with a motorcycle, as an example of an in-line-seating arrangement vehicle.

### DETAILED DESCRIPTION OF THE INVENTION

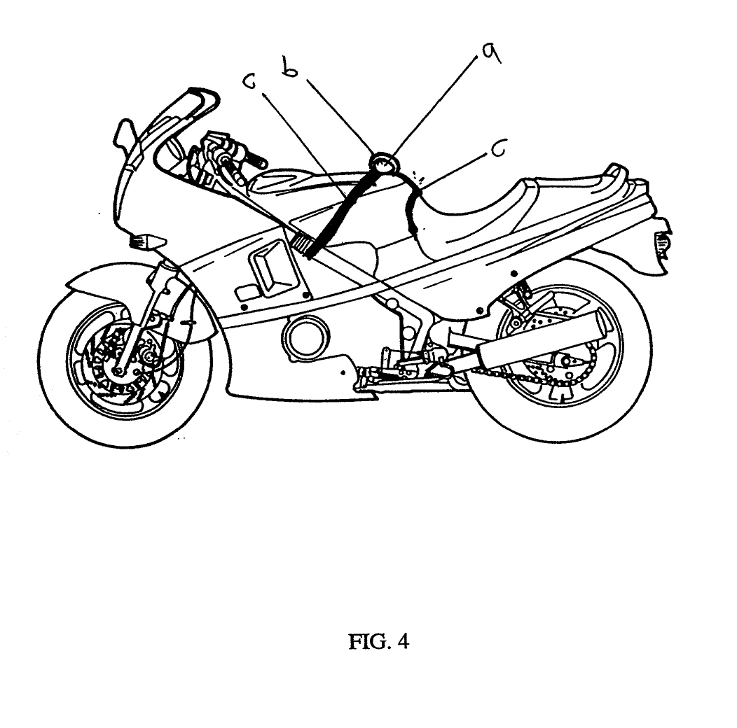

The Passenger Safety Handlebar is comprised of three components fastened together, which are then fixed to the fuel tank of the vehicle (see FIG. 4) in a plurality of points. These three components are described herein and defined below, and are essentially, but not limited to, the (a) ‘bar’, the (b) ‘mounting device’, and the (c) ‘straps’.

The Passenger Safety Handlebar consists of (a) a bar or rod (henceforth ‘bar’) of a rigid material such as inflexible metal tubing, which is laterally mounted on the vehicle such as to extend outwards from the vehicle in either direction, terminating at a position comfortably exterior to the vehicle. The preferred embodiment of the bar is a non-curved, rigid cylinder of length 60 cm (two feet) and diameter 2.5 cm (one inch). The preferred embodiment of the bar is such that it is coated in a non-abrasive material, such as cloth, synthetic, or rubber. The preferred embodiment of the bar is such that it has padded or rubberized hand-grips affixed to either terminal end for improved comfort and ergonomic application. The preferred embodiment of the bar is such that it may be flattened around the area of the midsection, to allow for enhanced driver comfort. The extrapolations of the invention include slight curving of the bar for comfort on some model vehicles, telescoping, retractable, and quick-release (hook-on) mounting versions.

The Passenger Safety Handlebar consists of (b) a central mounting bracket, loop, unit or device (henceforth ‘mounting device’) that secures the bar to the rest of the invention. The mounting device is such that it is affixed to the bar, encompassing and/or anchoring the bar, and further providing a support for the bar to separate it from its position on the vehicle. The mounting device is constructed of a flexible, strong, non-abrasive material, such as a canvas-like cloth, or nylon or leather strapping. The mounting device is affixed to the bar by means of penetrating fasteners, rivets, or is sewn or otherwise secured around the bar. The preferred embodiment of the mounting device consists of a wide (5 cm, 2 inch) loop of canvas or synthetic strapping which encircles the bar, and provides a mounting location for the fastening straps (to follow). Extrapolations of the mounting device include modification by padding for comfort to the driver, and alteration to allow for additional devices to be anchored to it.

The Passenger Safety Handlebar consists of (c) a plurality of fastening straps, loops, cords, ties or other mechanisms (henceforth ‘straps’) which extend from the central mounting device. The function of the straps is to securely attach the invention to the vehicle, as depicted (see FIG. 4). The preferred embodiment of the straps will vary from vehicle to vehicle, due to the multiplicity of anchor points and configurations. The following preferred embodiment is described for attaching the Passenger Safety Handlebar to a motorcycle, which possesses accessible frame structures located on either side forward, and singly to the reverse of the fuel tank. (This configuration is commonly used for in-line-seating arrangement vehicles.) This preferred embodiment consists of canvas, cloth, or nylon strapping, 2.5 cm (one inch) in width, and sufficient length to extend from the central mounting device to the forward frame of the vehicle in each direction forwards, and singly to the reverse of the mounting device. The above strapping includes a buckle, anchor, or clasp which may serve to tighten the straps between the mounting device and the frame of the vehicle, resulting in equivalent tension in all directions, and against the body of the vehicle, namely the fuel tank.

The combined preferred embodiment of the Passenger Safety Handlebar in use with a motorcycle of above description is as described herein. The composition includes a bar, as described above (a), 60 cm in length, non-curved, and coated in non-abrasive rubber polymer, affixed to a loop of wide canvas strapping (b), and secured by means of rivets or other fastening devices. The composition include fastening straps (c), which extend forward in a ‘Y’ formation equally forward to the left and right of the mounting device (b), and singularly to the reverse. Convenient anchor points on many vehicles are the frame, forward and below the fuel tank, and the frame directly in front of the seat, behind the fuel tank.

The preferred method of manufacture of the Passenger Safety Handlebar is to assemble the bar (a) and the straps (c) and the mounting device (b) in an open position on a level surface. Following this, to roll the mounting device over such as to form a loop around the straps (c) and bar (a), and further to secure this with fasteners, using pre-drilled holes in the bar (a).

The primary distinction between the old (prior art) inventions is summarily that this device is rigid in composure and fixed-mounted. This improvement allows for better control over the passenger's weight transfer and balance and relieves the driver of the demands of the passengers inertia, than other belt- or harness-based predecessors.

I claim as my invention:

1. A rigid rod-like structure (henceforth “bar”) of convenient length, laterally securable to an in-line seating-arrangement vehicle, such as a motorcycle, for use by the passenger of such a vehicle for the purpose of increased safety, stability, and comfort.

2. A bar of claim 1 which may be secured to the vehicle through the use of a mounting device, harness, or the like.

3. A bar of claim 2 which may be secured to the vehicle by a plurality of mounting straps, ties, or the like (henceforth “straps”) namely by the use of snaps, hooks, clips, fasteners, or the like.

4. A bar of claim 3 which may be easily removed through the use of semi-permanently mounted hooks, loops, fasteners, or the like secured to the vehicle, and an appropriately complementing set of hooks, loops, fasteners, or the like attached to the straps or the mounting device of the bar.

5. A bar of claim 4 which is modified in such a way as to increase the comfort and ease of use, namely through the utilization of grips, padding, covers, liners, adhesive tape, or any synthetic material.

6. A bar of claim 1 which is modified or constructed in such a way so as to increase convenience of use, namely through the utilization of telescoping, curved, detachable, segmented, or retractable extrapolations.
